(19) United States
(12) Patent Application Publication
(10) Pub. No.: US 2005/0022343 A1
(43) Pub. Date: Feb. 3, 2005

(54) Intermediate cord for manufacturing nonwovens of fibrous material as well as method for manufacturing nonwovens of fibrous material

(76) Inventors: Siegfried Bernhardt, Bremen (DE); Robert Kamprath, Brake (DE); Heinz-Werner Naumann-Burghardtz, Berne (DE)

Correspondence Address: Vincent L. Ramik;DILLER, RAMIK & WIGHT, 7345 McWhorter Place; Suite 101, Annandale, VA, 22315, US

(21) Appl. No.: 10/899,043

(22) Filed: Jul. 27, 2004

(30) Foreign Application Priority Data
Jul. 29, 2003 (EP) 03 017 145.8

(51) Int. Cl. B65G 47/46; B65G 47/10; B65G 43/08; D01G 15/00

(52) U.S. Cl. 19/98

(57) ABSTRACT

In an intermediate card for manufacturing nonwovens of fibrous material, with a drawing-in means (2), with at least one main cylinder (4), and with several fiber take-off means (6a, 6b, 6c) for taking over at least two card webs from the main cylinder (4), the at least two card webs being adapted to be deposited as a nonwoven onto a common conveying belt of a conveying means, it is provided that each fiber take-off means (6a, 6b, 6c) transfers the taken-off card webs onto transfer sections (15a, 15b, 15c, 15d) circumferentially offset with respect to each other and forming part of a permeable conveying surface (15) curved in a circularly cylindrical manner, the circumferential speed of which is adapted to the transfer speed of the card webs at the transfer sections (15a, 15b, 15c, 15d) as to direction and amount, the transfer sections of the conveying surface (15) being sucked.

### BACKGROUND OF THE INVENTION

1. Field of the Invention

The invention relates to an intermediate card for manufacturing nonwovens of fibrous material according to the precharacterizing part of claim 1 as well as to a method for manufacturing nonwovens of fibrous material according to the precharacterizing part of claim 11.

2. Description of Related Art

Such an intermediate card is known, for example, from European Patent 484 812 A. In this intermediate card, each of two fiber take-off means takes a card web from a main cylinder and deposits it on a respective conveyor belt by means of stuffer and take-off rollers. In the course of this, the conveyor belt of a fiber take-off means transfers a card web onto a conveyor belt of another fiber take-off means so that eventually, all card webs are able to be carried away as a nonwoven on a common conveyor belt.

With several intermediate cards arranged behind each other, it is known from European Patent 817 875 A to deposit the card web of the intermediate card mechanically on a common conveyor belt which is sucked throughout in the region of the card web. Such an installation facilitates the realization of high-speed carding installations permitting production speeds of more than 150 m/min, preferably of more than 200 m/min up into the range of from 400 to 500 m/min.

In the last-mentioned state of the art, the take-off of two card webs from the main cylinder is provided, the card webs being doubled on a common succeeding roller.

It is also known to transfer two card webs taken off from a main cylinder onto a common conveyor belt after each other, said conveyor belt being sucked at the transfer site.

### SUMMARY OF THE INVENTION

It is the object of the present invention to improve the transfer of repeatedly taken-off card webs onto a common conveyor belt and to permit a more compact structure of an intermediate card.

This object is solved, according to the invention, with the features of claims 1 and 11, respectively.

The invention advantageously provides that each fiber take-off means transfers the taken-off card webs onto transfer sections of a permeable conveying surface curved in a circularly cylindrical manner, said transfer sections being mutually offset in circumferential direction. The circumferential speed of the conveying surface is adapted to the transfer speed of the card webs from the fiber take-off means as to direction and amount, the conveying surface being sucked at the transfer sections.

The invention provides a take-off system in which a guided transfer of individual card webs onto a common parallel conveyor belt is permitted. The permeable conveying surface curved in a circularly cylindrical manner permits a more favorable deposition angle at the transfer sections. The curved surfaces at the transfer sections make it easier to take out the fibers at the take-off roller of the fiber take-off means in connection with the sucking of the conveying surface in the region of the transfer sections. The superposition of the card webs in rapidly succeeding transfer sections also permits a better connection between the upper web and the bottom web as well as a compact construction of the intermediate card. The conveying surface curved in a circularly cylindrical manner permits a transfer of the card webs to the conveyor belt which is poor in distortion, so that higher production speeds are possible.

In one embodiment, it is provided that the permeable conveying surface is formed by a rotating screening drum. The screening drum takes over several card webs at different transfer sections, which are transferred in common onto a permeable conveyor belt of a conveying means at a transfer site where the suction flow into the screening drum is at least interrupted or reversed.

The conveyor belt is adapted to be sucked at the transfer site between the screening drum and the conveyor belt from the side of the conveyor belt opposite the transfer site.

According to another preferred embodiment, it is provided that a permeable endlessly circulating conveyor belt of a conveying means loops a rotating screening drum at least in the region of the transfer sections of the conveying surface and carries away the card webs lying on top of each other and sucked by the screening drum onto the conveyor belt. The speed of the conveyor belt corresponds to the circumferential speed of the rotating screening drum. This embodiment also follows the principle that a curved surface of a last roller of the fiber take-off means transfers the card web onto the permeable conveying surface curved in a circularly cylindrical manner.

Preferably, it is provided that the conveying means is adapted to be pivoted about an axis coaxial to the axis of the screening drum in such a manner that the transfer site of the conveyor belt for the common card web from the conveying means to a succeeding means is height-adjustable.

The fiber take-off means may comprise at least one doffer roller being in engagement with the main cylinder. In another embodiment, it is provided that the fiber take-off means comprises at least one tangling roller being in engagement with the main cylinder, transferring the card web onto at least one doffer roller. One or more fiber take-off means may comprise one tangling roller, respectively, each of which takes over one card web from the main cylinder. From the respective tangling roller of a fiber take-off means, the card web can be transferred to one or more doffer rollers.

Preferably, each doffer roller is in engagement with at least one succeeding stuffing roller and a take-off roller or only a take-off roller.

In a preferred embodiment, it is provided that the drawing-in means with drawing-in rollers and a licker-in comprises at least one tangling roller between the licker-in and the main cylinder, which rotates in the same direction as the main cylinder and the licker-in.

It may also be provided that the fibers are transferred from the licker-in to the main cylinder on at least two paths.

Hereinafter, several embodiments of the invention are explained in detail with reference to the drawings.

### BRIEF DESCRIPTION OF THE DRAWINGS

In the Figures:

FIG. 1 shows a first embodiment of an intermediate card with a screening drum.

FIG. 2 shows a second embodiment where the screening drum is surrounded by a permeable conveyor belt.

FIG. 3 shows an embodiment without stuffing rollers.

FIG. 4 shows an embodiment where three card webs are adapted to be transferred onto the conveyor belt.

FIG. 5 shows a drawing-in means of the intermediate card.

FIG. 6 shows an embodiment of a tangling roller on the web take-off side of the main cylinder.

FIG. 7 shows an embodiment with two tangling rollers.

### DETAILED DESCRIPTION OF THE PREFERRED EMBODIMENTS

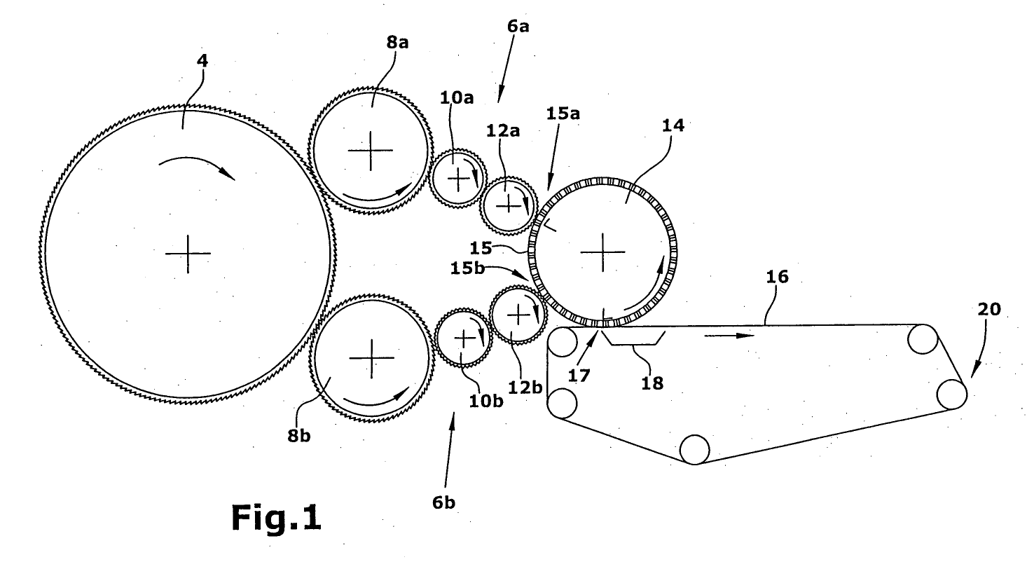

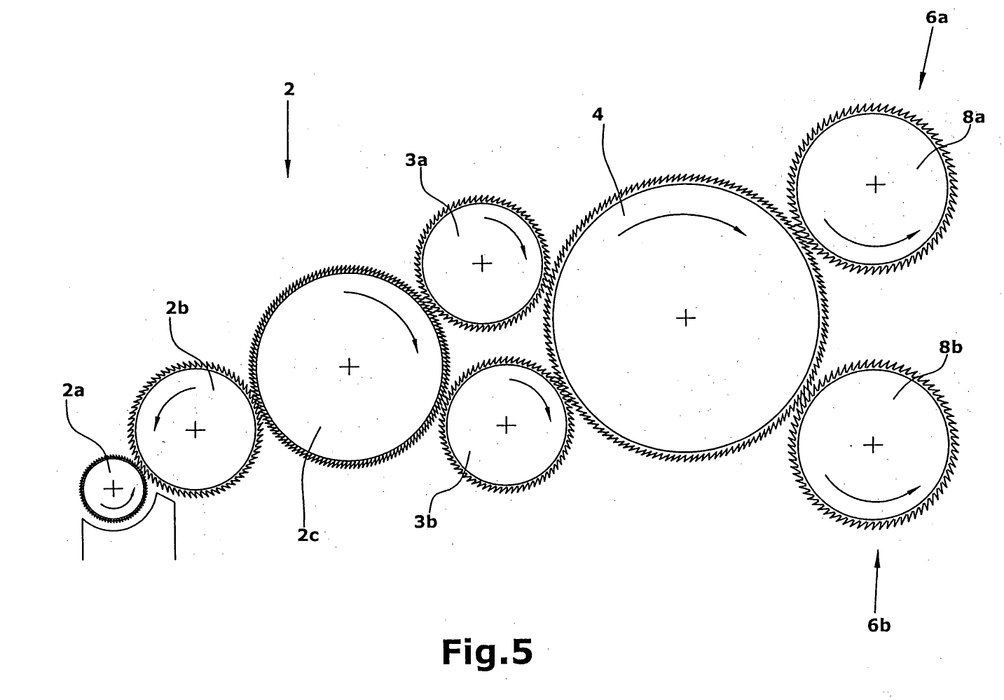

The portion of an intermediate card on the card web take-off side shown in FIG. 1 comprises a drawing-in means 2 by means of which fibers are transferred onto a main cylinder 4. A possible embodiment of a drawing-in means 2 with tangling rollers 3a, 3b is apparent from FIG. 5. Each of two fiber take-off means 6a, 6b on the card web take-off side of the intermediate card takes one card web off the main cylinder 4 and transfers it onto a screening drum 14 forming a permeable conveying surface 15 curved in a circularly cylindrical manner and being adapted to be partially sucked in the interior so that an airflow from outside to inside flows through the jacket surface of the screening drum 14 in a predetermined segment.

Each fiber take-off means 6a, 6b is comprised of a doffer roller 8a,8b and at least one take-off roller 12a, 12b, at least one stuffing roller 10a,10b being able to be arranged between the doffer roller 8a,8b and the take-off roller 12a, 12b.

The screening drum 14 forms a permeable conveying surface 15 curved in a circularly cylindrical manner onto which the card webs transferred by the fiber take-off means 6a, 6b can be transferred at transfer sections 15a, 15b circumferentially offset with respect to each other. The transfer sections 15a, 15b are located at the narrowest sites between the take-off rollers 12a, 12b and the conveying surface 15. As to direction and amount, the circumferential speed of the screening drum at its conveying surface is adapted to the transfer speed of the card webs at the transfer sections 15a, 15b. Preferably, the screening drum 14 is sucked in a segment extending from the take-off roller 12a to a transfer site between the screening drum 14 and a conveyor belt 16. The delimitation of the sucked region is indicated by angle symbols.

The advantage of the segmented sucking of the screening drum 14 also consists in that only a small air volume is necessary to be able to securely transfer the card webs at the transfer sites even at high transport speeds when the fiber take-off means 6a, 6b are laterally sealed. On the underside, the permeable conveyor belt 16 may comprise a suction box 18 at the transfer site 17 between the screening drum 14 and the conveyor belt 16, which suction box sucks the conveyor belt at the transfer site and in a predetermined region behind the transfer site. Alternatively, the underside of the conveyor belt may be provided with air guide blades 22 between the transfer site between the screening drum and the conveyor belt up to a site of transfer 20 to a succeeding machine, said guide blades providing for a secure adhesion of the card webs on the conveyor belt 16 as a consequence of the deflection of an airflow below the conveyor belt.

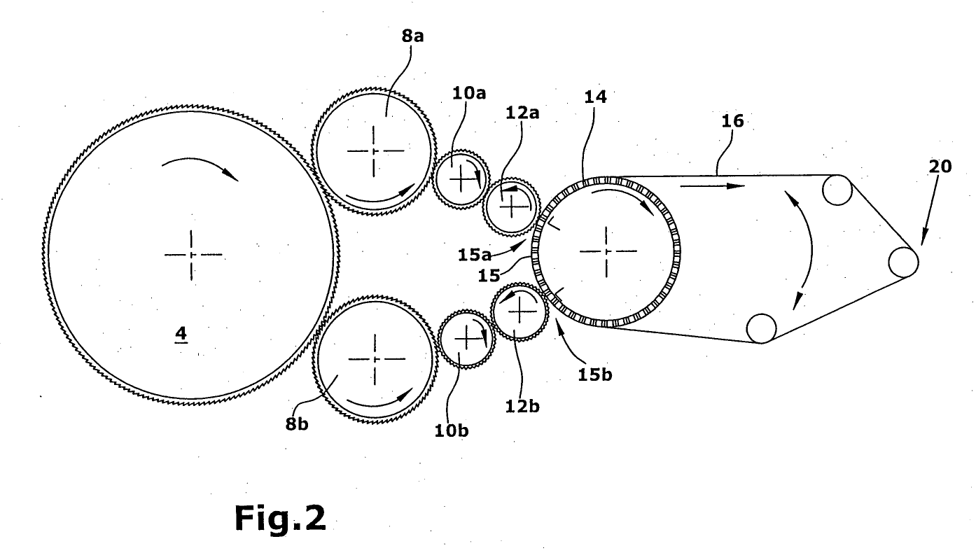

FIG. 2 shows an embodiment where the conveyor belt 16 loops the screening drum 14 and is moved at the same speed as the circumferential speed of the screening drum 14. The preferred solution avoids any further transfer site between a screening drum 14 and the conveyor belt 16 and thus permits an even more compact construction of the intermediate card.

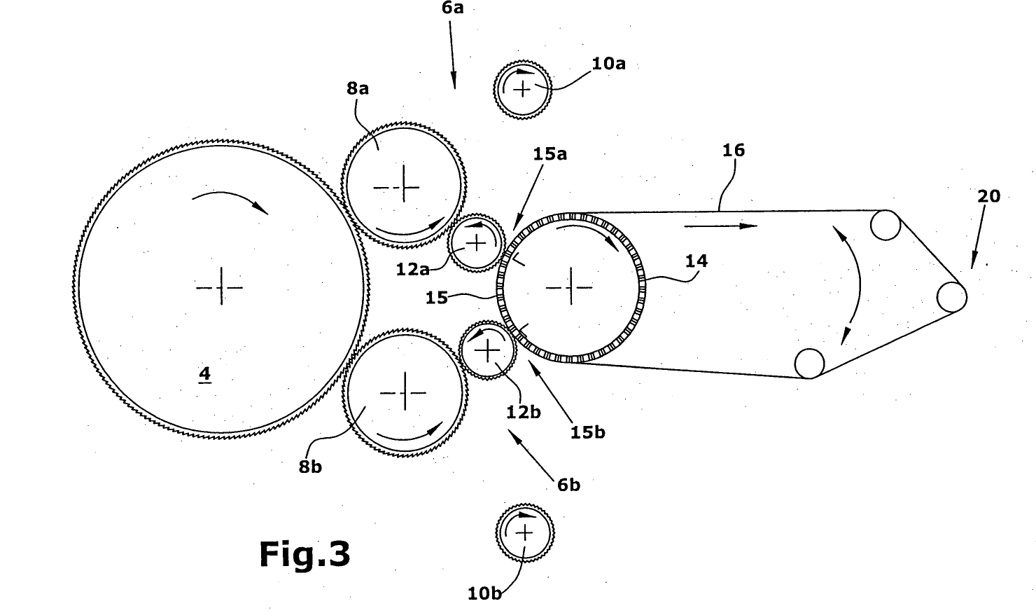

FIG. 3 shows an embodiment where pivotable stuffing rollers 10a,10b are shown in a position of being pivoted away in which they are no longer in engagement with the doffer rollers 8a, 8b and the take-off rollers 12a, 12b.

By a suitable pivoting means, the stuffing rollers 6a, 6b can be brought out of or into engagement.

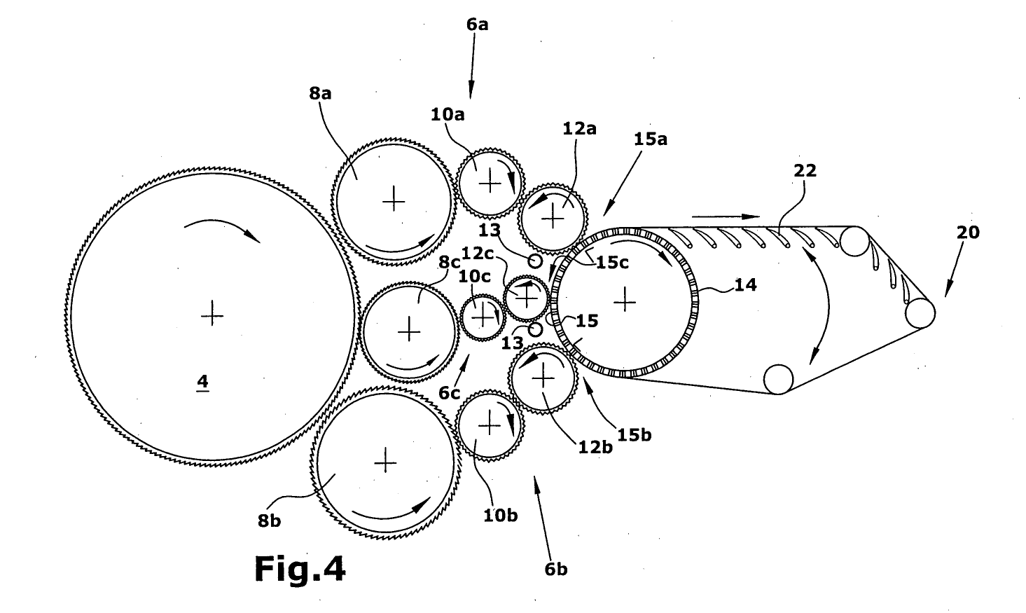

Finally, FIG. 4 shows an embodiment where altogether three fiber take-off means 6a, 6b, 6c are provided so that a total of three card webs on the endlessly circulating conveyor belt 16 in connection with the permeable conveying surface 15 formed together with the screening drum 14 can be disposed at transfer sites 15a, 15b, 15c.

This permits the production of a high-performance intermediate card with a high mass per unit area of the resulting card web at a high production speed and with a short and compact construction.

In the embodiments of FIGS. 2 to 7, the screening drum 14 may also be sucked completely instead of in segments. It goes without saying that the conveyor belt 16 may also comprise air guide blades 22 at the underside between the point of separation from the screening drum 14 to the site of transfer 20 to the succeeding machine in the embodiments of FIGS. 2 to 7.

In all embodiments, it may be provided that the conveying means with the conveyor belt 16 is adapted to be pivoted about the rotational axis of the screening drum 14 so that the height of the site of transfer 20 to a succeeding machine is adjustable.

Between the take-off rollers 12a, 12b, 12c, 12d of all embodiments, air guiding means 13 such as tubes as shown in FIG. 4 can be arranged to reduce cross-flows.

FIG. 5 shows an embodiment of a drawing-in means 2 with a drawing-in roller 2a, a taker-in 2b and a licker-in 2c. Two tangling rollers 3a, 3b are arranged between the licker-in 2c and the main cylinder 4. The tangling rollers 3a, 3b permit a return at the licker-in so that the carding performance of the licker-in 2c can be used repeatedly. It goes without saying that a single tangling roller 3 only may be in engagement with the licker-in 2c and the main cylinder 4. The tangling rollers 3a, 3b rotate in the same direction as the main cylinder 4 and the licker-in 2c.

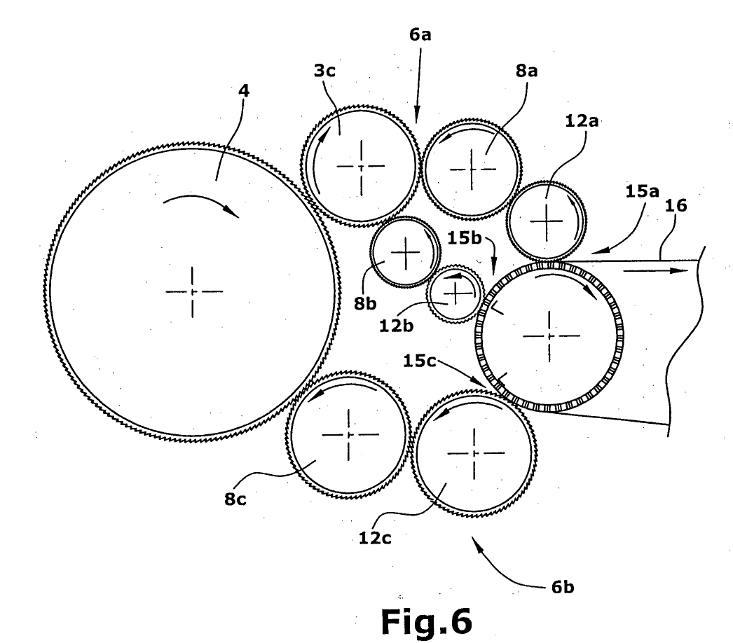

FIG. 6 shows an embodiment where the upper fiber take-off means 6a comprises a tangling roller 3c being in engagement with the main cylinder 4 as only roller of the fiber take-off means 6a.

The tangling roller 3c rotates in the same direction as the main cylinder 4 and in opposite direction to the rotational direction of two doffer rollers 8a, 8b being in engagement with the tangling roller 3c. Thus, the card web transferred from the main cylinder 4 to the tangling roller 3c is shared out between two doffer rollers 8a, 8b and transferred from there via take-off rollers 12a, 12b or stuffing rollers in combination with take-off rollers 12a, 12b onto the conveying surface 15 of the screening drum 14 and the conveying belt 16, respectively.

In the embodiment of FIG. 6, the lower fiber take-off means 6b is comprised of a doffer roller 8c being in engagement with the main cylinder 4 and a take-off roller 12c being in engagement with the doffer roller 8c, on the one hand, and transferring the card web onto the conveying belt 16 at the screening drum 14, on the other hand.

It goes without saying that the lower fiber take-off means may also be configured as illustrated in the other embodiments.

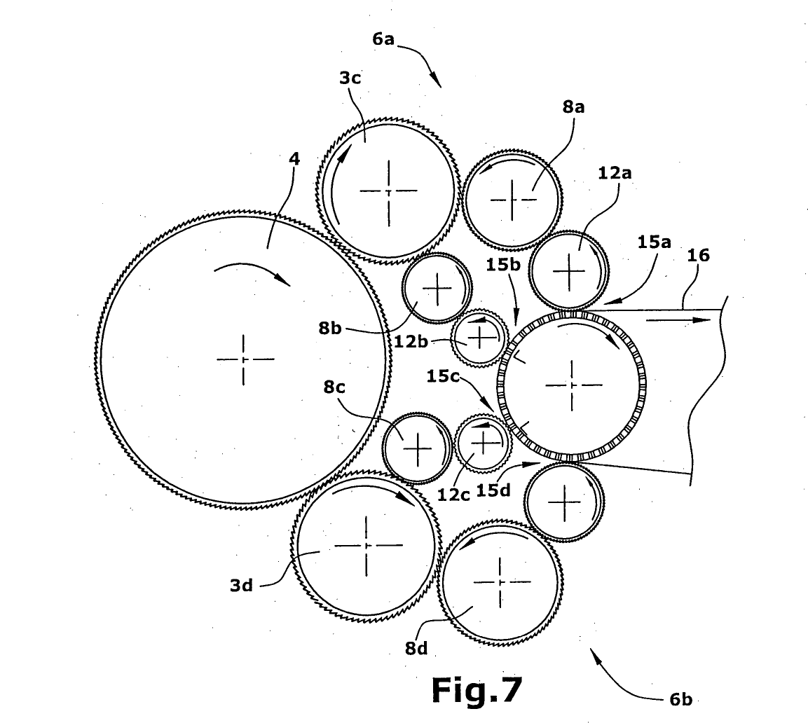

FIG. 7 shows a further embodiment where the lower fiber take-off means 6b is configured as an about mirrored representation of the upper fiber take-off means 6a. Consequently, the lower fiber take-off means comprises a tangling roller 3d being in engagement with the main cylinder 4, sharing out the card web between two doffer rollers 8c and 8d. It goes without saying that stuffing rollers may be arranged between the take-off rollers 8a to 8d and the take-off rollers 12a to 12d in this embodiment as well.

The diameter of the main cylinder amounts to approximately 1.200 to 1.800 mm, preferably 1.500 mm, the diameter of the tangling rollers being between 400 and 700 mm, preferably 550 mm.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. An intermediate card for manufacturing nonwovens of fibrous material,
with a drawing-in means (2),
with at least one main cylinder (4), and
with several fiber take-off means (6a, 6b, 6c) for taking over at least two card webs from the main cylinder (4), the at least two card webs being adapted to be deposited as a nonwoven onto a common conveying belt of a conveying means,
characterized in
that each fiber take-off means (6a, 6b, 6c) transfers the card webs taken off onto transfer sections (15a, 15b, 15c, 15d) circumferentially offset with respect to each other and being part of a permeable conveying surface (15) curved in a circularly cylindrical manner, the circumferential speed of which is adapted to the transfer speed of the card webs at the transfer sections (15a, 15b, 15c, 15d) as to direction and amount, the transfer sections of the conveying surface (15) being sucked.

2. The intermediate card according to claim 1, characterized in that the permeable conveying surface (15) is formed on a rotating screening drum (14).

3. The intermediate card according to claim 2, characterized in that the conveying surface (15) of the screening drum (14) transfers the taken-over card webs onto a permeable conveying belt (16) of the conveying means at a transfer site (17) where the suction flow into the screening drum (14) is interrupted or reversed to a blowing flow from the screening drum (14).

4. The intermediate card according to claim 3, characterized in that the conveying belt (16) is adapted to be sucked under the transfer site (17) between the screening drum (14) and the conveying belt (16).

5. The intermediate card according to claim 1, characterized in that a permeable endlessly circulating conveying belt (16) of a conveying means loops a rotating screening drum (14) at least in the region of the transfer sections (15a, 15b, 15c, 15d) of the conveying surface (15) and that the permeable conveying surface (15) is formed in common by the conveying belt (16) and the screening drum (14) supporting the conveying belt (16).

6. The intermediate card according to claim 1, characterized in that the conveying means is adapted to be pivoted about an axis coaxial to the axis of the screening drum (14) such that the site of transfer (20) of the conveying belt (16) for the nonwoven from the conveying means to a succeeding means further processing the nonwoven is height-adjustable.

7. The intermediate card according to claim 1, characterized in that the fiber take-off means (6a, 6b, 6c) comprise at least one doffer roller (8a, 8b, 8c) being in engagement with the main cylinder (4).

8. The intermediate card according to claim 1, characterized in that the fiber take-off means (6a, 6b, 6c) comprise at least one tangling roller (3c, 3d) being in engagement with the main cylinder (4), which transfers the card web onto at least one doffer roller (8a, 8b; 8c, 8d).

9. The intermediate card according to claim 7, characterized in that each doffer roller (8a, 8b, 8c, 8d) is in engagement with at least one succeeding stuffing roller (10a, 10b, 10c) or a take-off roller (12a, 12b, 12c, 12d).

10. The intermediate card according to claim 1, characterized in that the drawing-in means (2) comprises at least one tangling roller (3a, 3b) rotating in the same direction as the main cylinder (4).

11. A method for manufacturing a nonwoven of fibrous material
by feeding the fibrous material via a drawing-in means (2) of an intermediate card,
by combing the fibrous material on a main cylinder (4) of the intermediate card,
by taking off at least two card webs from the main cylinder,
by carrying away the nonwoven formed of card webs on a common conveying belt,
characterized in
that each taken-off card web is transferred onto transfer sections (15a, 15b, 15c, 15d) circumferentially offset with respect to each other and forming part of a permeable conveying surface curved in a circularly cylindrical manner, the transfer sections (15a, 15b, 15c, 15d) being adapted to be sucked at the conveying surface (15) and the circumferential speed being adapted to the transfer speed of the card webs as to direction and amount.

12. The method according to claim 11, characterized in that the conveying surface (15) is formed by a rotating screening drum (14) from which the taken-off card webs are transferred onto a permeable conveying belt (16) as a nonwoven.

13. The method according to claim 11, characterized in that the conveying surface (15) is formed on a permeable conveying belt (16) looping a rotating screening drum (14) adapted to be sucked.

14. The method according to claim 11 characterized in that each card web is taken off the main cylinder (4) directly by a doffer roller (8a, 8b; 8c, 8d) or by a tangling roller (3c, 3d) with a succeeding doffer roller (8a, 8b; 8c, 8d).

15. The method according to claim 14, characterized in that each card web taken over from the main cylinder (4) by a tangling roller (3c, 3d) is shared out between at least two doffer rollers (8a, 8b, 8c, 8d).

16. The method according to claim 11, characterized in that each card web of a doffer roller (8a, 8b, 8c, 8d) is transferred onto the conveying surface (15) curved in a circularly cylindrical manner via a take-off roller (12a, 12b, 12c, 12d) with or without a stuffing roller (10a, 10b, 10c, 10d) being inserted.

17. The intermediate card according to claim 8, characterized in that each doffer roller (8a, 8b, 8c, 8d) is in engagement with at least one succeeding stuffing roller (10a, 10b, 10c) or a take-off roller (12a, 12b, 12c, 12d).

18. The method according claim 12 characterized in that each card web is taken off the main cylinder (4) directly by a doffer roller (8a, 8b; 8c, 8d) or by a tangling roller (3c, 3d) with a succeeding doffer roller (8a, 8b; 8c, 8d).

19. The method according to claim 13 characterized in that each card web is taken off the main cylinder (4) directly by a doffer roller (8a, 8b; 8c, 8d) or by a tangling roller (3c, 3d) with a succeeding doffer roller (8a, 8b; 8c, 8d).

20. The method according to claim 12, characterized in that each card web of a doffer roller (8a, 8b, 8c, 8d) is transferred onto the conveying surface (15) curved in a circularly cylindrical manner via a take-off roller (12a, 12b, 12c, 12d) with or without a stuffing roller (10a, 10b, 10c, 10d) being inserted.

21. The method according to claim 13, characterized in that each card web of a doffer roller (8a, 8b, 8c, 8d) is transferred onto the conveying surface (15) curved in a circularly cylindrical manner via a take-off roller (12a, 12b, 12c, 12d) with or without a stuffing roller (10a, 10b, 10c, 10d) being inserted.
